(19) United States
(12) Patent Application Publication
(10) Pub. No.: US 2007/0097793 A1
(43) Pub. Date: May 3, 2007

(54) Electronic timer

(76) Inventors: Samuel Eak Hua Nguy, Hong Kong (CN); George Carl Atamian, Upland, CA (US)

Correspondence Address: Ketan S. Vakil, Esq.;SNELL & WILMER L.L.P., Suite 1400, 600 Anton Boulevard, Costa Mesa, CA, 92626-7689, US

(21) Appl. No.: 11/265,969

(22) Filed: Nov. 3, 2005

(51) Int. Cl. G04B 19/26

(52) U.S. Cl. 368/15

(57) ABSTRACT

An electronic timer having a memory for storing programming information including astronomical sunset, sunrise, evening, dawn or twilight data for at least one geographic location, a processor for generating a time controlled signal; and a switch, responsive to the time controlled signal, for receiving an input power from a power supply and coupling the input power to at least one AC socket. The astronomical data can be used in setting an operating time corresponding to the geographic location of the user. Each AC socket can operate independently from the other. The electronic timer further includes a random selection unit used to randomly select an activation and/or deactivation times based on a number of setting parameters that provides a different operating time for each day of the year and for each AC socket.

### FIELD OF THE INVENTION

The invention relates generally to electronic timers that activate or deactivate electrical devices such as lights. More particularly, the invention relates to timers programmed to turn a light on and off at predetermined times that correspond to the geographic location of the user or at random times operating within programmed temporal parameters.

### DESCRIPTION OF THE RELATED ART

Conventional electrical timers are commonly used to turn lights on and off in a dwelling or business, thereby, giving the appearance that the premises is occupied. This helps in deterring burglars from breaking into the premises when its occupants are away.

Electrical timers also provide illumination that helps reduce accidents associated with insufficient illumination.

One of the problems associated with these timers is that they turn on the same lights every night at the same selected activation time. One can easily ascertain that the house is not occupied by observing this repetitive operation over a period of days. Some timers allow lights to turn on at random times within a preselected random time interval of a selected activation time. Typically, the preselected random time interval is within 15-20 minutes of the selected activation time. This random operation avoids the repetitive activation time of conventional electronic timers. Normally, the programming of multiple random times is so difficult that most consumers abandon the effort.

Even the electronic timers with random operation have limitations. For instance, the timers may not adjust to daylight savings time and would require the user to update the timer's clock setting. Furthermore, even if the timers are advanced enough to correct for daylight savings time, they do not adjust for the varying sunset times throughout the year. Hence, if a user sets the timer to turn on at around 9 pm during the summer, he or she will have to readjust the timer settings in the fall and winter to correspond to an earlier sunset time. Adjustments are required more frequently when the sun is in the mid-latitudes, moving North or South. Most home or business owners do not have the time or opportunity to constantly tune their timers.

While U.S. Pat. No. 4,922,407 discloses an astronomical timer unit that can be preset to operate at dusk or dawn, this system also has limitations. It requires the user to enter local time of sunrise or the local time of sunset on the particular month and day to which the clock is currently set, and then uses an algorithm to calculate the subsequent times of local sunrise and sunset based on the time of year and the geographical location of the timer. Not only is this system susceptible to human error by virtue of entering the wrong sunset or sunrise times, it is also inaccurate because the algorithm only provides an estimate and not the exact sunset time.

Some electronic devices activate and deactivate their switching mechanism in response to photocell sensors. The sensor detects arrival of nighttime and automatically turns on the light after a certain time period from nightfall. These devices, such as the one disclosed in U.S. Pat. No. 4,575,659, require a photocell arrangement that increase the cost and complexity of the electronic timer unit. Furthermore, these photocell devices do not incorporate randomizing features, nor can they be precisely programmed to activate and deactivate at set times. They are also restricted to activating one device as they have only one socket.

While many of these timers work to turn the lights on and off, they fail to accurately account for the different sunset times corresponding to the user's geographic location and the time of year. Accordingly, it is an object of the present invention to provide an electronic timer that is programmed with accurate sunset and/or sunrise information specifically for a user's geographic location—latitude and longitude. The latter determines the user's location within a given time zone, which is compensated by the programming in the electronics.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a front view of an actual electronic timer incorporating an embodiment of the present invention.

FIG. 2 is a side view of an actual electronic timer incorporating an embodiment of the present invention.

FIG. 3 is a top view of an actual electronic timer incorporating an embodiment of the present invention.

FIG. 4 is a circuit design of an electronic timer incorporating an embodiment of the present invention.

FIG. 5 is a block design of an electronic timer incorporating an embodiment of the present invention.

FIG. 6 is a flow chart of the operation of an electronic timer incorporating an embodiment of the present invention.

FIG. 7 is a flow chart of a program executed by the processor in an electronic timer incorporating an embodiment of the present invention.

### SUMMARY OF THE INVENTION

The present invention provides an electronic timer with stored astronomical data such as sunset, sunrise, evening, dawn or twilight data, for a specific geographic location that is used in setting an activation time.

The stored astronomical data could also be for multiple geographic locations. A user selects a city or country from the data base, or simply enters a city or country code, to trigger the processor to retrieve the appropriate astronomical data from memory.

A random selection unit randomly selects a time in a pre-selected random time interval on either side of an activation time. For instance, the electronic timer can be set to randomly activate within a pre-selected of 15 minute time interval from evening twilight onset.

The random selection unit adjusts activation time on any operating day by an amount corresponding to the time difference or deviation between the astronomical data for that operating day and the astronomical data that the user entered. A new random activation or deactivation time will be set within the pre-selected 15 minute time interval, based on the adjusted activation or deactivation times.

More than one AC socket may be provided. Each AC socket operates independently from the other. A random selection unit selects the activation time for each AC socket separated by a pre-selected minimum time interval.

### DETAILED DESCRIPTION

Methods and apparatus that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, like reference numbers represent like elements.

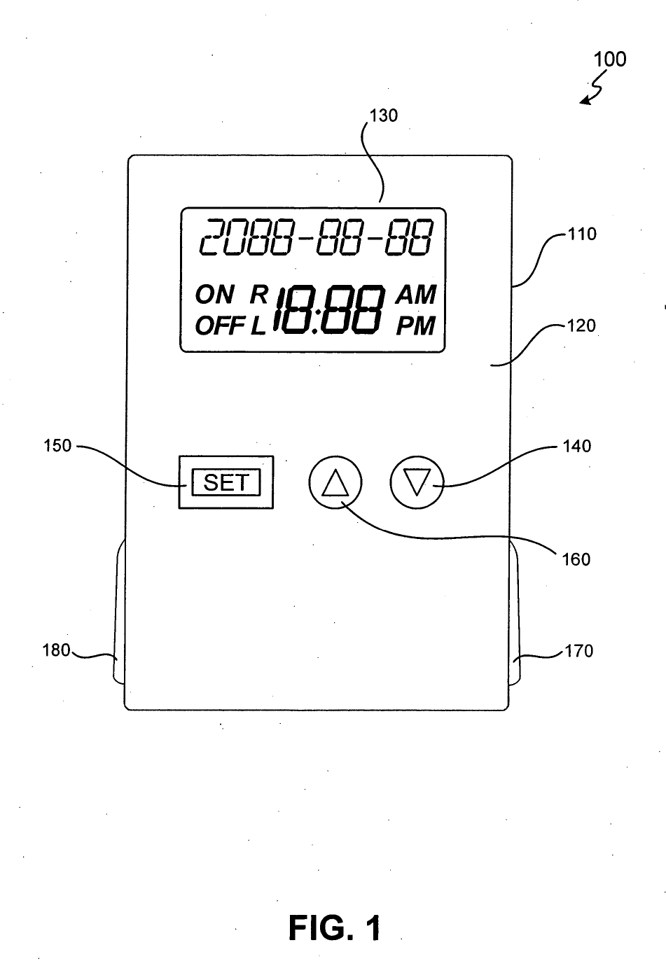

FIG. 1 illustrates the front of an actual electronic timer 100. The actual electronic timer 100 has a housing 110 with a face 120. A display unit 130 and an input device 140 are mounted on the face 120 of the housing 110. The display unit 130 can be a conventional liquid crystal display screen. An input device 140 can be a set of buttons or a touchpad screen for entry of selected information. In one embodiment, the input device 140 has three buttons: a mode/set button 150 for selecting the electronic timer's mode of operation, and scroll buttons 160 for moving up or down a list of information. The selected information can be any information that a user can enter or select using the input device 140. The information can be any information stored in memory, such as astronomical sunset, sunrise, evening, dawn or twilight data, listing of geographical locations, and date and time information such as Standard Time (“ST”) and Daylight Savings Time (“DT”).

The electronic timer 100 can have more than one grounded AC socket. Each socket can be programmed to operate independently of the other. In one embodiment, the housing 110 contains a first AC socket 170 and a second AC socket 180, mounted on opposite sides of the housing 110.

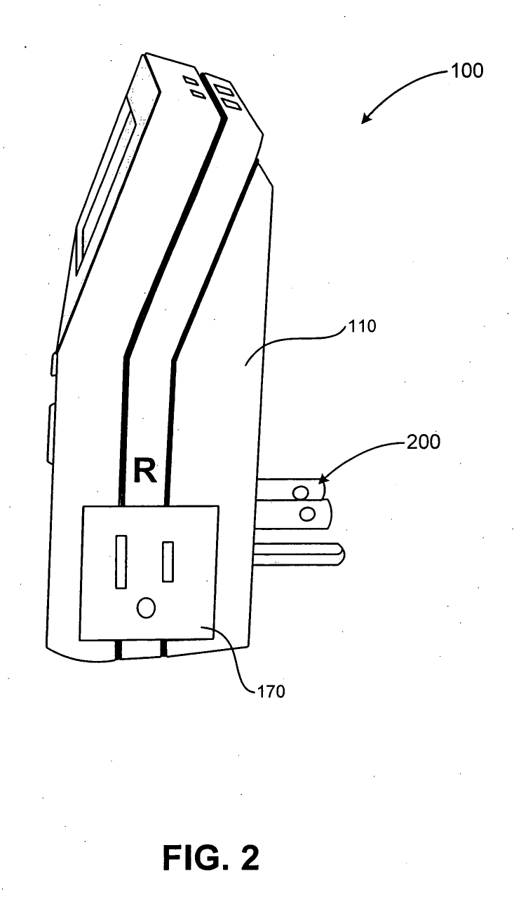

FIG. 2 illustrates a side view of the electronic timer 100 with the first AC socket 170 mounted on one side of housing 110. Extending from the rear side of the electronic timer 100 is a conventional plug 200 for insertion into a conventional AC socket. The plug 200 may be a 3-prong or a 2-prong plug.

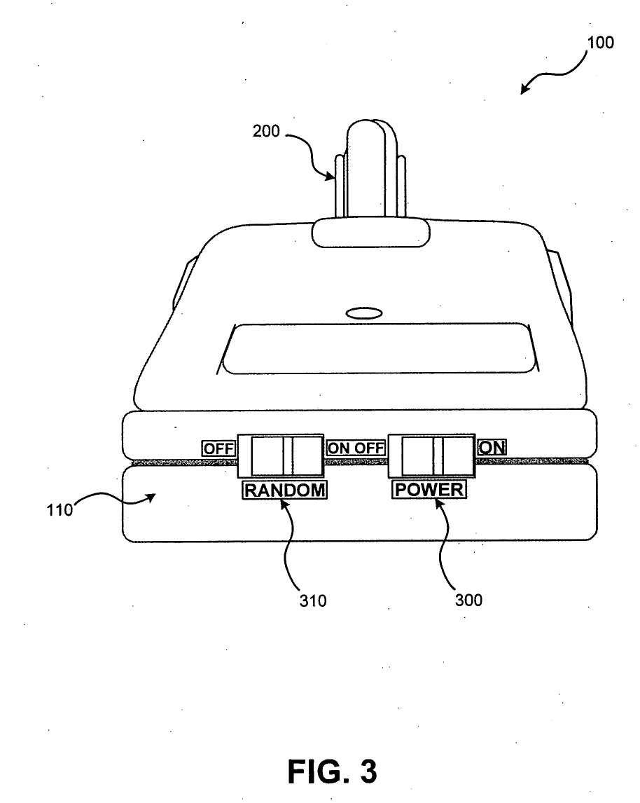

FIG. 3 shows a top view of the electronic timer 100. The electronic timer 100 has a power switch 300 mounted on the top side of housing 110. The power switch 300 controls the power supply transmitted to the two AC sockets 170 and 180. The power switch 300 can be set mechanically using a slide switch, or can be set electronically using the input device 140. The power switch 300 can be used to control the power supply to all AC sockets 170 and 180 simultaneously, or control the power supply to each AC socket 170 and 180, selectively.

Mounted in housing 110 is a random selection unit. The random selection unit can be set mechanically using, for example, the slide switch 310, or electronically using, the input device 140. The electronic timer 100 can have one random selection unit 310 to control the activation and deactivation of all AC sockets 170 and 180. The electronic timer 100 can also have separate random activation units for each AC socket 170 and 180, such that the user can select which AC socket 170 or 180 would operate randomly.

When the random selection unit 310 is switched on, a time is selected, at random, within a pre-selected time interval of an activation or deactivation time. For example, if the activation time was set to 6:00 P.M., the timer with a pre-selected time interval of plus or minus fifteen minutes will turn on at some time between 5:45 P.M. and 6:15 P.M. If the random selection unit 310 is switched off, the electronic timer 100 will operate at substantially the set activation and deactivation times.

The user can also set the activation and deactivation times of the electronic timer 100 using the input device 140 to enter the operating times. The activation and deactivation times can also be preprogrammed by the manufacturer. For example, the activation and deactivation times can be retrieved from a memory containing astronomical data such as sunset and sunrise times. The activation or deactivation times can be set at a time substantially equal to the astronomical data. Both activation and deactivation time settings can adjust for daylight savings time change. In one embodiment, the deactivation time can be preprogrammed to turn off after a certain time period from the activation time. For instance, the deactivation time can be set to turn off after five hours from the activation time. In another embodiment, the deactivation time can be preprogrammed to turn off at a specific time for a specific location. For example, the deactivation time can be set to turn off at 11:30 P.M. for all locations, except Alaska where it would turn off at 12:30 A.M.

Table 1 provides exemplary astronomical sunset data for the city of Los Angeles in March. The first column of Table 1, lists the dates in the month. The second column lists corresponding sunset data for a geographical location. This data may be obtained from the U.S. Naval Observatory. The third column indicates the activation time stored in the electronic timer 100. This time is set to be substantially equal to the astronomical data. The fourth column shows the expected activation time of the timer. If the random selection unit 310 is switched on, the activation time is set to equal the activation time in column 3. The fifth column provides an exemplary list of times that the electronic timer 100 turns on. If the random selection unit 310 is switched on, the time is randomly selected within a pre-selected time interval of 15 minutes from the expected activation time of column 4. The sixth column lists the expected deactivation time, which is preset to turn off the electronic timer 100 after five hours from the expected activation time. The seventh column provides an exemplary list of times that the electronic timer 100 turns off. These times are within a pre-selected time interval of 15 minutes from the expected deactivation time.

TABLE 1

| | | | Expected | Actual | Expected | Actual |
|---|---|---|---|---|---|---|
| | Actual | Stored | Acti- | Acti- | Deacti- | Deacti- |
| | Sunset | Sunset | vation | vation | vation | vation |
| Date | Data | Data | Time | Time | Time | Time |
| 3.1 | 17:50 | 17:51 | 17:51 | 17:51 | 22:51 | 22:51 |
| 3.2 | 17:51 | 17:51 | 17:51 | 17:57 | 22:51 | 22:52 |
| 3.3 | 17:52 | 17:52 | 17:52 | 18:04 | 22:52 | 22:42 |
| 3.4 | 17:53 | 17:53 | 17:53 | 17:50 | 22:53 | 22:54 |
| 3.5 | 17:54 | 17:54 | 17:54 | 18:04 | 22:54 | 23:00 |
| 3.6 | 17:54 | 17:55 | 17:55 | 17:53 | 22:55 | 22:50 |
| 3.7 | 17:55 | 17:56 | 17:56 | 17:54 | 22:56 | 23:03 |
| 3.8 | 17:56 | 17:57 | 17:57 | 18:11 | 22:57 | 23:08 |
| 3.9 | 17:57 | 17:57 | 17:57 | 18:03 | 22:57 | 22:51 |
| 3.10 | 17:58 | 17:58 | 17:58 | 17:57 | 22:58 | 22:47 |
| 3.11 | 17:59 | 17:59 | 17:59 | 17:58 | 22:59 | 22:53 |
| 3.12 | 17:59 | 18:00 | 18:00 | 18:02 | 23:00 | 22:48 |
| 3.13 | 18:00 | 18:00 | 18:00 | 18:09 | 23:00 | 22:58 |
| 3.14 | 18:01 | 18:01 | 18:01 | 17:48 | 23:01 | 23:11 |
| 3.15 | 18:02 | 18:02 | 18:02 | 17:50 | 23:02 | 23:05 |
| 3.16 | 18:02 | 18:03 | 18:03 | 17:50 | 23:03 | 23:13 |
| 3.17 | 18:03 | 18:03 | 18:03 | 17:55 | 23:03 | 23:18 |
| 3.18 | 18:04 | 18:04 | 18:04 | 17:54 | 23:04 | 23:18 |
| 3.19 | 18:05 | 18:05 | 18:05 | 18:04 | 23:05 | 23:04 |
| 3.20 | 18:06 | 18:06 | 18:06 | 18:10 | 23:06 | 23:01 |
| 3.21 | 18:06 | 18:06 | 18:06 | 17:57 | 23:06 | 22:55 |
| 3.22 | 18:07 | 18:07 | 18:07 | 17:57 | 23:07 | 22:58 |
| 3.23 | 18:08 | 18:08 | 18:08 | 17:58 | 23:08 | 23:20 |
| 3.24 | 18:09 | 18:09 | 18:09 | 18:18 | 23:09 | 23:24 |
| 3.25 | 18:09 | 18:10 | 18:10 | 18:12 | 23:10 | 22:56 |
| 3.26 | 18:10 | 18:10 | 18:10 | 18:09 | 23:10 | 22:56 |
| 3.27 | 18:11 | 18:11 | 18:11 | 18:08 | 23:11 | 22:58 |
| 3.28 | 18:12 | 18:12 | 18:12 | 18:13 | 23:12 | 23:23 |
| 3.29 | 18:12 | 18:13 | 18:13 | 18:21 | 23:13 | 23:18 |
| 3.30 | 18:13 | 18:13 | 18:13 | 18:19 | 23:13 | 23:12 |
| 3.31 | 18:14 | 18:14 | 18:14 | 18:07 | 23:14 | 23:24 |

The random selection unit 310 can trigger the processor of the electronic timer 100 to adjust the activation or deactivation times set by a user. If the random selection unit is switched on, the activation and/or deactivation times set by the user can be adjusted by an amount corresponding to the time difference between a reference time, such as a time retrieved from astronomical data on the day the timer is set by the user, and a time retrieved from astronomical data on the operating day. This is illustrated in Table 2. If the sunset time stored in the electronic timer 100 for March 1st is 5:51 P.M. (Table 2, Col. 3, Row 1), and the user sets the activation time as 7:00 A.M. and deactivation time as 9:00 A.M., then on March 3rd, with a stored sunset time of 5:52 P.M., the random selection unit 310 will trigger the processor to adjust the activation and deactivation times by the time difference between 5:51 P.M. and 5:52 P.M., one second. The adjusted expected activation time is 7:01 A.M. and the adjusted expected deactivation time is 9:01 A.M. If the random selection unit is switched on, a random time is selected within a pre-selected random time interval on either side of the adjusted expected activation and/or adjusted expected deactivation times (as shown in Table 2, Cols. 5 & 7).

TABLE 2

| | | | Expected | Actual | Expected | Actual |
|---|---|---|---|---|---|---|
| | Actual | Stored | Acti- | Acti- | Deacti- | Deacti- |
| | Sunset | Sunset | vation | vation | vation | vation |
| Date | Data | Data | Time | Time | Time | Time |
| 3.1 | 17:50 | 17:51 | 7:00 | 7:00 | 9:00 | 9:00 |
| 3.2 | 17:51 | 17:51 | 7:00 | 6:47 | 9:00 | 8:51 |
| 3.3 | 17:52 | 17:52 | 7:01 | 7:07 | 9:01 | 9:12 |
| 3.4 | 17:53 | 17:53 | 7:02 | 6:58 | 9:02 | 8:56 |
| 3.5 | 17:54 | 17:54 | 7:03 | 7:15 | 9:03 | 8:57 |
| 3.6 | 17:54 | 17:55 | 7:04 | 6:51 | 9:04 | 8:56 |
| 3.7 | 17:55 | 17:56 | 7:05 | 7:18 | 9:05 | 9:18 |
| 3.8 | 17:56 | 17:57 | 7:06 | 7:02 | 9:06 | 9:03 |
| 3.9 | 17:57 | 17:57 | 7:06 | 6:59 | 9:06 | 9:18 |
| 3.10 | 17:58 | 17:58 | 7:07 | 7:07 | 9:07 | 9:12 |
| 3.11 | 17:59 | 17:59 | 7:08 | 7:00 | 9:08 | 9:54 |
| 3.12 | 17:59 | 18:00 | 7:09 | 7:08 | 9:09 | 9:17 |
| 3.13 | 18:00 | 18:00 | 7:09 | 7:18 | 9:09 | 9:03 |
| 3.14 | 18:01 | 18:01 | 7:10 | 7:01 | 9:10 | 8:55 |
| 3.15 | 18:02 | 18:02 | 7:11 | 7:12 | 9:11 | 9:15 |
| 3.16 | 18:02 | 18:03 | 7:12 | 7:10 | 9:12 | 9:24 |
| 3.17 | 18:03 | 18:03 | 7:12 | 7:05 | 9:12 | 9:13 |
| 3.18 | 18:04 | 18:04 | 7:13 | 7:05 | 9:13 | 9:26 |
| 3.19 | 18:05 | 18:05 | 7:14 | 7:06 | 9:14 | 9:26 |
| 3.20 | 18:06 | 18:06 | 7:15 | 7:15 | 9:15 | 9:30 |
| 3.21 | 18:06 | 18:06 | 7:15 | 7:04 | 9:15 | 9:30 |
| 3.22 | 18:07 | 18:07 | 7:16 | 7:06 | 9:16 | 9:29 |
| 3.23 | 18:08 | 18:08 | 7:17 | 7:10 | 9:17 | 9:07 |
| 3.24 | 18:09 | 18:09 | 7:18 | 7:18 | 9:18 | 9:03 |
| 3.25 | 18:09 | 18:10 | 7:19 | 7:28 | 9:19 | 9:24 |
| 3.26 | 18:10 | 18:10 | 7:19 | 7:19 | 9:19 | 9:12 |
| 3.27 | 18:11 | 18:11 | 7:20 | 7:05 | 9:20 | 9:10 |
| 3.28 | 18:12 | 18:12 | 7:21 | 7:24 | 9:21 | 9:35 |
| 3.29 | 18:12 | 18:13 | 7:22 | 7:13 | 9:22 | 9:29 |
| 3.30 | 18:13 | 18:13 | 7:22 | 7:36 | 9:22 | 9:14 |
| 3.31 | 18:14 | 18:14 | 7:23 | 7:24 | 9:23 | 9:29 |

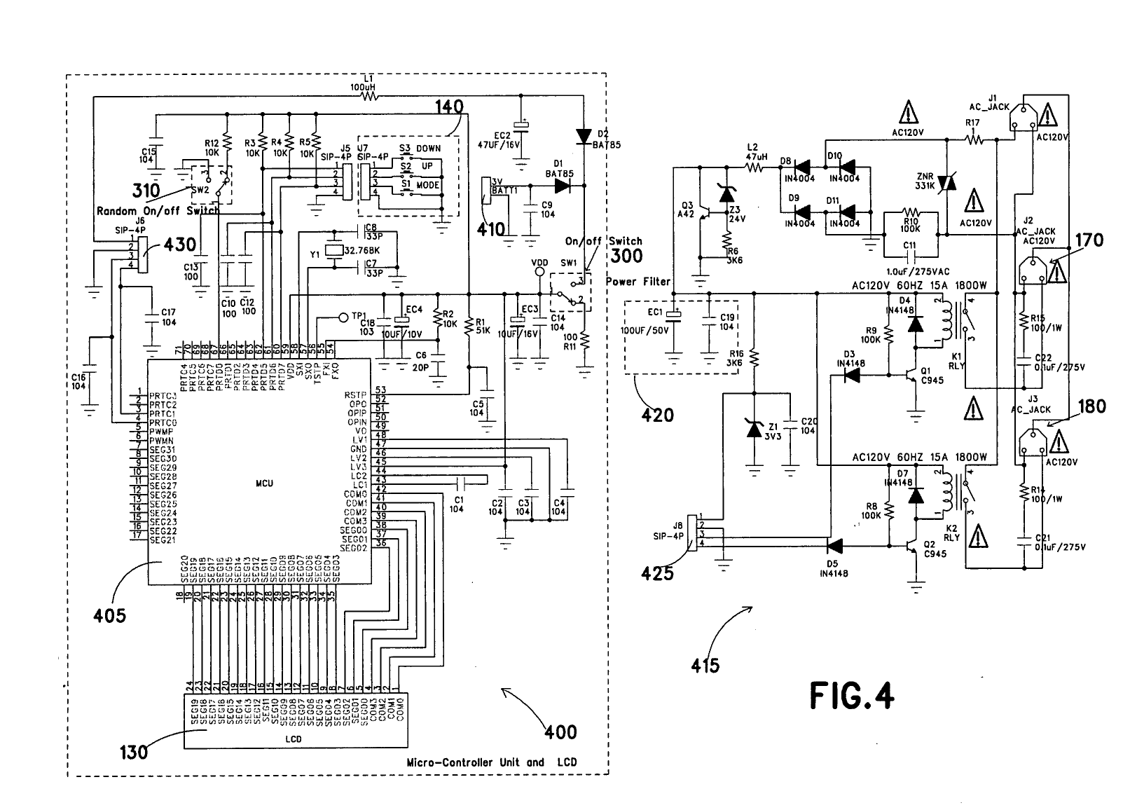

FIG. 4 illustrates an exemplary schematic diagram of a circuit for an electronic timer 100. The left circuit 400 represents a low voltage circuit comprising a display unit 130, a Micro-Controller Unit (MCU) 405, a battery 410, and an input device 140. The right circuit 415 represents the high voltage comprising AC sockets 170 and 180, and AC Power Control 420. The left circuit 400 and the right circuit 415 are connected through connection 425 and connection 430. The MCU 405 could be a central processor unit, such as the one manufactured by Jess Technology Co., Ltd.

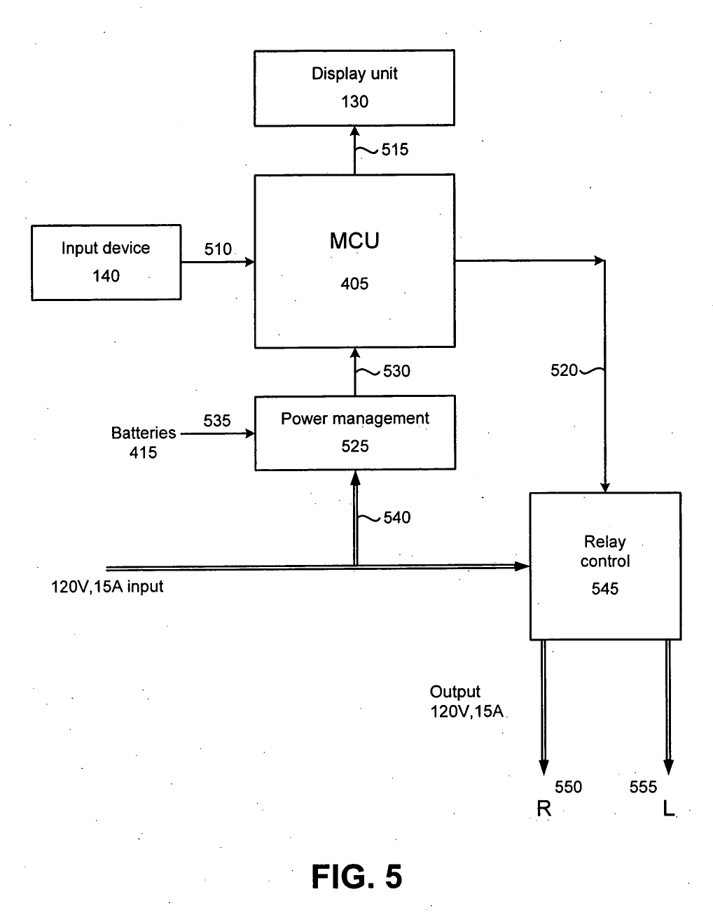

Referring to FIG. 5, the MCU 405 processes selected information from the input device 140 (510), and outputs messages to the display unit 130 (515). The MCU 405 also provides functions such as calendar, random timing, and sunset tables for at least one geographical location. The MCU 405 controls the relays (520) of at least one AC socket 170 and 180.

Power management 525 of FIG. 5 corresponds to circuit elements D1, D2, Z1, Z3, D8, D9, D10, D11 of FIG. 4. Power management 525 provides electrical power to the MCU 405 (530). If there is no AC input, the MCU 405 will use power from the battery 415 through D1 (535). However, if the electronic timer 100 is plugged to a wall socket, the MCU 405 will use power from the AC line through circuit elements D8, D9, D10, D11, Z3, Z1 and D2 (540).

The MCU 405 controls 545 the two relays K1 and K2 through its output pins PRTC0 (550) and PRTC1 (555). These two signals, through J6 and J8, are fed to D3 and D5, and thus control the ON or OFF of the two relays.

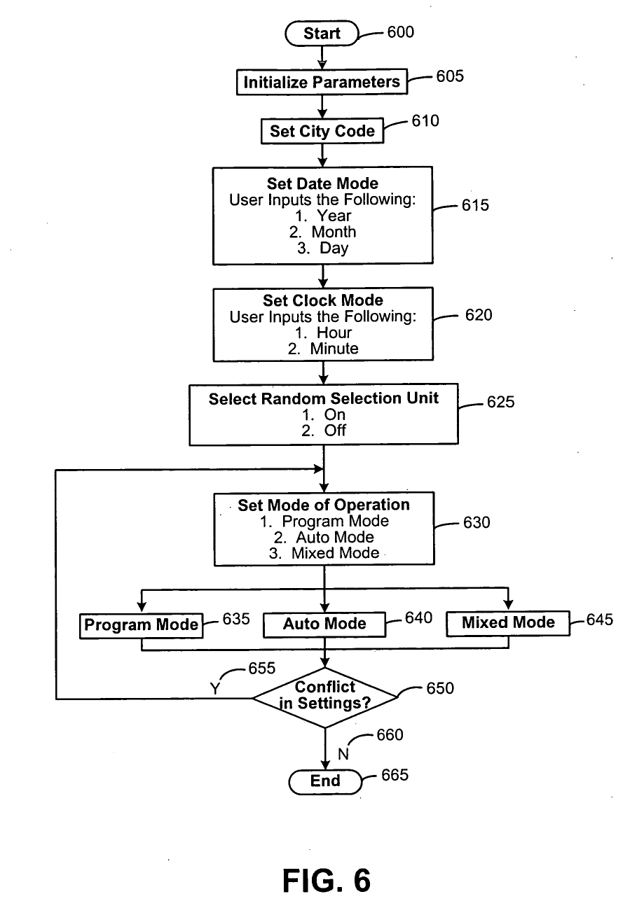

FIG. 6 is a flow chart logic diagram depicting operation of an electronic timer 100. In the first step, the processor initializes all relevant parameters (605). In one mode of operation, the user is prompted to set a city code (610) by using the input device 140. In another mode of operation, the user can select a geographical location from a preprogrammed list of cities and/or countries. Through successive use of the mode button 150, the user can scroll through all the programmed options, including date mode (615) and clock mode (620), and set all relevant selected information. It will be recognized that any or all selected information can be preprogrammed by the manufacturer without requiring the user to input any information in the electronic timer 100.

Next, the processor checks if the random selection unit 310 is switched on or off (625). If the random selection unit 310 is switched off, then the electronic timer will operate at a time substantially equal to the activation and deactivation times. Since the activation and deactivation times can be set by the user or preprogrammed by the manufacturer, the processor checks which mode of operation (630) is set for the electronic timer 100. There can be three modes of operation: program mode (635), auto mode (640), and mixed mode (645). The program mode (635) allows the user to set the activation and deactivation times for each AC socket 170 and 180. The auto mode (640) does not require the user to set any operating times. The electronic timer 100 will retrieve astronomical data, such as sunset, sunrise, evening, dawn or twilight times, from memory and use this information to automatically set activation and deactivation times for each AC socket 170 and 180.

The mixed mode (645) allows the user to input either an activation time or a deactivation time for each AC socket 170 and 180. If the user chooses to enter an activation time but not a deactivation time, the electronic timer 100 will turn on at the time set by the user and turn off at a pre-set time, such as 11:30 P.M. for all locations, except Alaska where it would turn off at 12:30 A.M. If the user enters a deactivation time only, the electronic timer 100 can retrieve sunset, sunrise, evening, dawn or twilight times from memory for activation time settings.

If the random selection unit 310 is switched on, then the electronic timer 100 will randomly select an operating time in a pre-selected random time interval on either side of the activation and deactivation times. In one mode of operation, the electronic timer 100 will randomly select different operating times for each operating day. The electronic timer 100 can be preprogrammed to randomly select an operating time outside a pre-selected minimum random time interval on either side of a previous operating time. For example, if the activation time is set at 4:58 P.M., then on the first operating day the random selection unit 310 can randomly select a time within a plus or minus fifteen minute deviation from 4:58 P.M., for instance, 4:51 P.M. On the second operating day, the random selection unit 310 would select a time outside a thirty minute window from the previous day such that the time is no later than 4:36 P.M. and not earlier than 5:06 P.M.

After determining the mode of operation, the processor dynamically checks (650) for improper settings. The processor can dynamically check if the activation and deactivation times are greater than a pre-selected minimum operating time interval. For example, the time interval between activation and deactivation must be greater than or equal to five minutes. In one embodiment, the pre-selected minimum operating time interval is different if the random selection unit 310 is switched on. For instance, the time interval between a randomly selected activation time and a randomly selected deactivation time should be greater than 31 minutes. Also, the processor dynamically checks if the activation time between each AC socket 170 and 180 is greater than a pre-selected minimum time interval. If the timer has detected that there is a conflict (655) with the rules in setting the electronic timer 100, the processor will clear all improper settings and automatically return to the setting interface to ask for resetting. However, if there are no conflicts (660) with the setting rules, then the processor will provide power supply to AC sockets 170 and 180 at the set operating time (665).

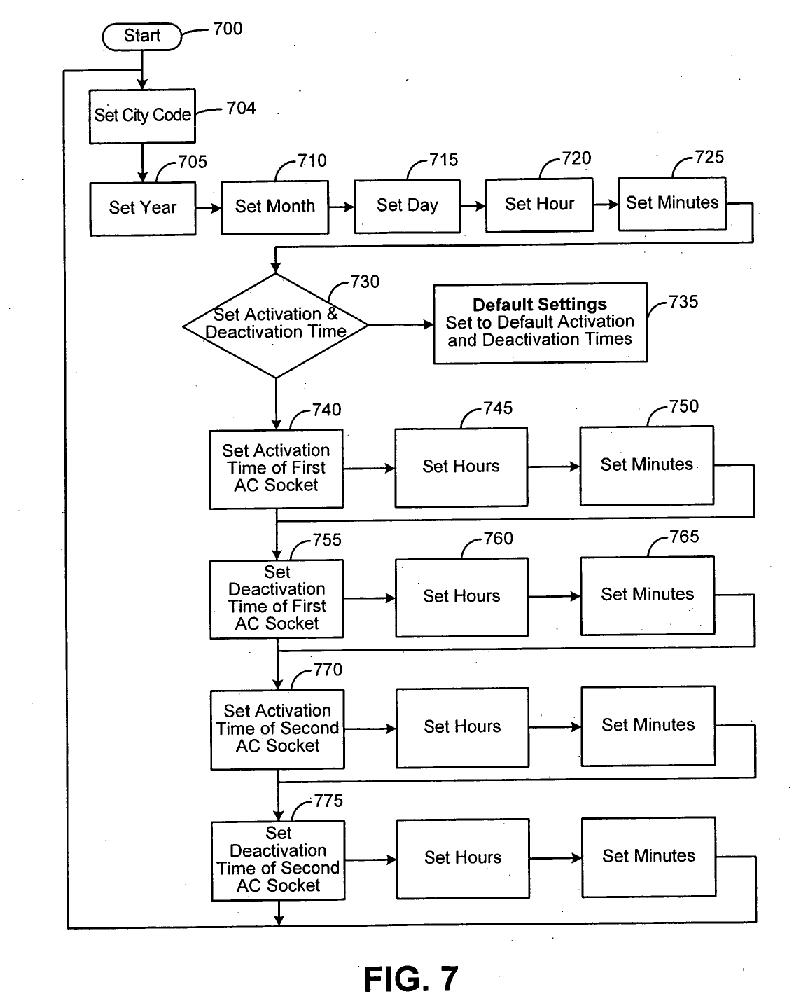

FIG. 7 is a flow chart showing a sequence of programmed processes occurring within the processor of an electronic timer 100. The user can use the mode button 150 to circulate through all the settings for entry of selected information. In one embodiment, the user can set a city code (704). The user is directed to an accompanying user manual with a listing of city codes. The default setting is “001” referring to New York, N.Y. The user can use the scroll buttons 160 to select the correct code corresponding to the user's geographical location. In another embodiment, the user can use the scroll buttons 160 to select a geographical location from a preprogrammed list of cities and/or countries or use the input device 140 to type in the geographical location.

Through successive use of the mode button 150, the user can set the year (705), the month (710), the day (715), the hour (720), the minutes (725), and activation and deactivation times (730). If the user does not set activation and deactivation times, then the electronic timer 100 will operate at the default settings. For example, the default or expected activation time can be a time substantially equal to sunset, sunrise, evening, dawn or twilight times. The default or expected deactivation time can be preprogrammed to turn off after a certain time period, for instance five hours, from the activation time. In one embodiment, the default deactivation time can be preprogrammed to turn off at a specific time for a specific location. For example, the default deactivation time can be set to turn off at 11:30 P.M. for all locations, except Alaska where it would turn off at 12:30 A.M.

If the user chooses to input activation and/or deactivation times for each AC socket 170 and 180, then the user must enter some selected information. The user can set the activation time (740) for the first AC socket 170 by entering the hours (745) and the minutes (750). Next, the user can set the deactivation time (755) of the first AC socket, also by entering the hours (760) and the minutes (765). Finally, the user can set the activation time (770) and deactivation time (775) of the second AC socket 180 in a similar fashion. The user can choose to keep the default settings for activation but only set the deactivation time, in which case the user would not enter an activation time. Similarly, the user also has the option of keeping the default settings for the deactivation time but only set the activation time. In either case, the processor would operate in mixed mode (645). It can be recognized to a person skilled in the art that any or all selected information can be preprogrammed by the manufacturer without requiring the user to input any programming information.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. An electronic timer comprising:
a memory for storing information including astronomical data of a geographic location used in setting an operating time for the electronic timer, the astronomical data being at least one of a sunset, sunrise, evening, dawn or twilight time;
a processor using the astronomical data to generate a time controlled signal; and
a switch, responsive to the time controlled signal, for receiving an input power from a power supply and coupling the input power to at least one AC socket.

2. The electronic timer of claim 1, wherein the operating time extends for substantially five hours from an activation time.

3. The electronic timer of claim 1, wherein the operating time is greater than a pre-selected minimum operating time interval.

4. The electronic timer of claim 1 further comprises an input device coupled to the processor, for entry of selected information comprising at least one of a geographic location code, a geographic location, a year, a month, a date, a time, and a mode of operation.

5. The electronic timer of claim 1 further comprises a power switch for controlling the power supply.

6. The electronic timer of claim 1, wherein each AC socket operates independently from one another.

7. The electronic timer of claim 1, further comprises a display unit coupled to the processor.

8. The electronic timer of claim 1 further comprises a random selection unit used to select, at random, a time in a preselected random time interval on either side of a reference operating time comprising at least one of the activation time or a deactivation time.

9. The electronic timer of claim 8, wherein the time, randomly selected from a preselected random time interval on the operating day, is separated from a previous randomly selected time of a previous day by a preselected minimum random time interval.

10. The electronic timer of claim 8,
wherein each AC socket operates independently,
wherein the random selection unit randomly selects at least one of the activation time or the deactivation time for each AC socket, and
wherein at least one of the activation time or the deactivation time for one AC socket is separated from that of another AC socket by a preselected minimum time interval.

11. The electronic timer of claim 8, wherein the random selection unit triggers the processor to adjust the reference operating time on the operating day by an amount corresponding to a time difference between the astronomical data of a reference day and the astronomical data of the operating day.

12. The electronic timer of claim 11, wherein the reference day is the date entered for the selected information.

13. An electronic timer comprising:
a memory for storing information including astronomical data of a geographic location, the astronomical data being of at least one of a sunset time and a sunrise time;
a processor using the astronomical data for generating a time controlled signal;
a switch, responsive to the time controlled signal, for receiving an input power from a power supply and coupling the input power to at least one AC socket;
a display unit coupled to the processor; and
a means for inputting selected information, the selected information comprising at least one of a geographic location code, a geographical location, a year, a month, a date, a time, and a mode of operation.

14. The electronic timer of claim 13, wherein each AC socket operates independently from one another.

15. The electronic timer of claim 13, wherein the operating time extends beyond an activation time by a preset time.

16. The electronic timer of claim 13 further comprises a random selection means for selecting, at random, a time in a preselected random time interval on either side of a reference operating time comprising at least one of the activation time or a deactivation time.

17. The electronic timer of claim 16, wherein the time, randomly selected from a preselected random time interval on the operating day, is separated from a previous randomly selected time of a previous day by a preselected minimum random time interval.

18. The electronic timer of claim 16, wherein each AC socket operates independently, and the random selection means selects, at random, the activation time for each AC socket separated by a preselected minimum time interval from each other.

19. The electronic timer of claim 16, wherein the random selection means triggers the processor to adjust the reference operating time on the operating day by an amount corresponding to a time difference between the astronomical data of the operating day and the astronomical data of the date entered for the selected information.

20. A method for programming an electronic timer comprising the steps of:
retrieving from memory information including astronomical data for more than one day of a geographic location, the astronomical data being at least one of a sunset time and a sunrise time;
generating a time controlled signal based on the information retrieved from memory;
activating at least one AC socket upon receipt of the time controlled signal; and
deactivating at least one AC socket upon expiration of operating time; the operating time extends beyond an activation time by a preset time.

21. The method of claim 20, further comprises the step of generating random operating times that are within a preselected random time interval on the operating day and separated from a previous randomly selected time of a previous day by a preselected minimum random time interval.

22. The method of claim 20, further comprises the step of generating a random activation time for each AC socket, wherein each random activation time is separated from one another by a pre-selected minimum time interval.

23. The method of claim 20, further comprises the step of generating a random deactivation time for each AC socket, wherein each random deactivation time is separated from one another by a pre-selected minimum time interval.

24. The method of claim 20, further comprises the step of generating random operating times within a preselected random time interval on either side of a reference operating time comprising at least one of the activation time or a deactivation time.

25. The method of claim 23, further comprises the step of adjusting the reference operating time on the operating day by an amount corresponding to a time difference between the astronomical data of a reference day and the astronomical data of the operating day.
